(19) United States
(12) Patent Application Publication
(10) Pub. No.: US 2023/0066860 A1
(43) Pub. Date: Mar. 2, 2023

(54) DECENTRALIZED INCENTIVIZED MIXNET

(71) Applicant: NYM Technologies SA, Neuchâtel (CH)

(72) Inventors: Harry Halpin, Neuchâtel (CH); Claudia Diaz, Leuven (BE)

(21) Appl. No.: 17/681,701

(22) Filed: Feb. 25, 2022

Related U.S. Application Data
(60) Provisional application No. 63/153,938, filed on Feb. 25, 2021.

(51) Int. Cl. H04L 9/00; H04L 9/32; G06Q 20/36

(52) U.S. Cl. CPC H04L 9/50; G06Q 20/367; H04L 9/3213

(57) ABSTRACT

A decentralized incentivized mixnet includes a blockchain token awarded to mixnet nodes that provision private computer network communication services via mixing packets and providing digital signatures. The blockchain token award are based on a combination of rewards and fees paid by users of the incentivized mixnet according to the reliability of packet mixing provided by the individual mix nodes in the network. The value of the blockchain token allows the mixnet to balance demand for privacy of mixing packets by users with the supply of computers run by the mixing nodes. Users may spend the mixnet access tokens by sending attribute certificates with evidence of identity to an identify provider for verification, triggering an issuance of a credential, transferring access tokens from the user’s wallet to a service provider via confirmation on a blockchain, revealing the credentials to a service provider.

### CROSS REFERENCE TO RELATED APPLICATIONS

This application claims priority to U.S. Provisional Application No. 63/153,938, filed Feb. 25, 2021 and entitled “Decentralized Incentivized Mixnet,” the entire disclosure of which is incorporated by reference in its entirety.

### BACKGROUND

Authentication technology allows a user of an information application to provide evidence of their identity in order to legitimately access the user’s account. The evidence may take the form of a credential such as a password, a code received via text-message, biometric data, or he possession of a cryptographic public key on the participant’s device or a trusted third-party information application. Various data, called attributes, needed for operations can be combined with this credential in order to provide the evidence needed to authenticate. In the prior art, such systems that used authentication technology and preserved the privacy of the user by not allowing a third-party access to data associated with the user, were centralized.

Blockchain technology provides a publicly transparent and decentralized ledger that is configured to track and store digital transactions in a publicly verifiable, secure, and hardened manner to prevent tampering or revision. Transactions or completed blocks in the blockchain are recorded and added to a chain in chronological order to allow market participants to keep track of digital currency transactions without central record keeping. Each node in the system gets a copy of the blockchain to maintain the decentralized ledger. The transactions or blocks in the blockchain are designed to be immutable so that they cannot be deleted.

Authentication systems suffer from drawbacks including single point of failure, potential for deplatforming of undesired users, prone to network level surveillance, selective censorship, and more. What is needed is a decentralized authentication solution that preserves the privacy of the user by protecting the user’s data against third party access on a censorship-resistant platform. Centralized authentication systems also do not provide an anonymous channel for the user, and so even if privacy-enhancing technology is used, including when it is used on blockchain with zero-knowledge proofs, the patterns of network traffic may still be visible.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates an example decentralized incentivized mixnet with a blockchain token according to an embodiment.

FIG. 2 illustrates an example architecture for a decentralized incentivized mixnet with a blockchain token according to an embodiment.

FIG. 3 illustrates an example flow for users and services to communicate privately according to an embodiment.

FIG. 4 illustrates an example system for obtaining and showing credentials according to an embodiment.

FIG. 5 illustrates an example flowchart for authentication on a decentralized incentivized mixnet.

### DETAILED DESCRIPTION

The system disclosed herein will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of decentralized privacy-enhanced authentication and anonymity system examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

A blockchain may be a map of public keys (addr) to values (v) given in NYM tokens. It may also be a set of transactions, as done by Bitcoin. Any component of the decentralized system may read the blockchain. In one example, the blockchain also maintains a list of valid serial numbers (s) for the tokens that have been transformed into credentials. Optionally, these serial numbers may be cryptographically transformed.

Conventional blockchain systems offer decentralized systems with public ledgers that reveal all the transactions occurring in the decentralized system, which is not suitable for high-risk transactions, such as those involving personal data. Current authentication technologies have an inherent flaw, as users desire to authenticate to a service provided by a service provider without revealing their personal identity to a service provider, but service providers need to protect their limited resources from malicious users and fake users that abuse and/or attack the system so the service providers desire to verify the personal identity of the user.

Note that the systems and methods embodied herein are independent of the particular blockchain used. Unlike U.S. Pat. 11,258,614 this disclosure does not use ring signatures for anonymous transactions and unlike U.S. Pat. 11,257,077 this disclosure does not require anonymous smart contracts. This disclosure does not record anything except the flow of token incentives for the nodes in the network, which may be either transparent, and a hash of a serial number on the blockchain to prevent double-spending of credentials.

This disclosure does not use traditional authorization tokens like U.S. Pat. 11,240,040 with a centralized public key infrastructure, but instead to the extent the issuance and verification of these credentials is to more than one validator. Although this disclosure can use credentials for privacy-enhanced identification, the credential transactions are not recorded on the blockchain except in the optional case of double-spending protection. Thus, the systems disclosed herein are unlike any decentralized identifier (DID) based system such as those given in U.S. Pat. 11,245,524 which records key material on the blockchain. Furthermore, the identity information itself is not stored in the blockchain for privacy, unlike U.S. Pat. 10,833,861 B2 which requires signatures for the ownership of the identity asset where the asset itself is represented by a hash.

This disclosure uses a mixnet in conjunction with credentials to provide privacy on both the layer of the network and any authentication needed to access the anonymous network system. Unlike prior work for verifiable shuffles in mixnets used in e-voting applications like U.S. Pat. 9,077,540, this disclosure uses a mixnet meant for general purpose communication such as generic internet traffic and does not verify shuffles. The mixnet in this disclosure can have a structured topology with multiple discrete layers and so is different than Tor (Dingledine, 2004) as well as the typical “cascade” mixnet deployed in the original mixnet design by Chaum (Chaum, 1981) or other peer-to-peer designs such as U.S. Pat. 10,855,578. The mixnet described herein does not require any use of chip cards, virtual or otherwise, or trusted third parties like U.S. Pat. 10, 575,416.

To protect against malicious users and fake users, service providers conventionally require users to submit personal information or rely on know your customer (KYC) techniques to verify customer information. In one example, the personal information submissions may require users to submit phone numbers or access codes to the service provider. In another example, the KYC techniques may verify customer information, such as names, phone numbers, and payment information. AML techniques (Anti-Money Laundering) could also be used to ensure the legality of the transaction. If the systems of the service providers are compromised, then the user-data may be accessed, linked to customer accounts, and/or stolen. Similarly, the conventional authentication techniques (such as using passwords, smart tokens, private key, and so forth) de-anonymize users by design and do not offer strong privacy guarantees.

Accordingly, the requirement of submitting personal information and the lack of strong privacy guarantees put users at risk for identity theft and compromise in which user identities may be revealed. Additionally, the inability of conventional authentication to support users that may require temporary or multiple identities is not easily possible. For example, not authenticating users can weaken an entire system. For example, letting all users through an anonymizing-network or allowing users to submit non-personal information (such as proof of electricity consumption) lets spammers to overrun and abuse the service. Not providing authentication prevents users from providing attributes needed by operations of the service, such as a long-term identifier and a list of contacts for messaging or an address for currency transfers that is required for accounting best practices. Furthermore, such zero-knowledge proof systems or attribute-based credential systems for selective disclosure credentials are computationally expensive and centralized. Additionally, attribute-based credential systems require users to install a special application on their device and so have had very low deployment rates.

Conventional privacy-enhancing services also do not need to limit the number of users and therefore risk overrunning their resources while making their service vulnerable to blacklisting if they interact with other services that view them as a source of abuse. Furthermore, because of the drawbacks of the conventional privacy-enhancing services, conventional privacy-enhancing services have not reached widespread deployment and require centralized authorities. These privacy-enhanced credentials that depend on centralized authorities are not usable within a decentralized environment because they are not publicly verifiable.

Anonymous communication systems allow information, in the form of one or more messages, to be sent from a sender to receiver where the messages themselves are not able to be linked to the sender or the receiver. This inability to link a message to its sender or the inability to link it to a receiver, or both, provides anonymity to the users of the system. These networks may be implemented as independent networks that could use specialized hardware, and can also be implemented using software on top of the existing internet as an privacy-enhanced overlay network that uses IP addresses. There are different kinds of anonymous communication systems. The most primitive and widely deployed is a VPN (Virtual Private Network) that de-links a sender of a message from their IP address via the use of an independent server that has a different IP address than the user. Tor is more advanced and deploys three independent servers to create a time-limited circuit (Dingledine, 2014). Mixnets route each message independently via one or more servers, called mix nodes (Chaum, 1981).

While other patents have been claimed on mixnet systems such as the foreign patent KR100668016B1, they discuss mixnets used similar to those of Chaum (1981). These mixnets all use a mix node with a finite number of encrypted messages, of possibly arbitrary length, and then permutate the messages to hide the sender the receiver as well as any pattern in the order of messages. Some inventions have taken this system and created records for verification, like foreign patent JP3540718B2. In contrast, modern mixnet designs used by this disclosure, such as Loopix (Piotrowska et al., 2011), break up messages into equal sized encrypted messages using a modern encrypted packet format like Sphinx (Danezis and Golderg, 2005) and then the messages are sent with user-defined or random timings embedding in each “hop” per mix node, so that the messages are released in a obfuscated order without waiting for a certain number of messages to be mixed. This allows the system to maximize anonymity while handling throughput. Unlike Loopix (Piotrowska et al., 2011), our invention deals practical concerns needed for usage of the mixnet, focussed both authentication to prevent denial-of-service and scaling the network with demand, including by the use of incentives.

To be more precise, a mix network, or mixnet, is an overlay network of mix nodes that routes messages anonymously. Similarly to Tor, each packet relayed via a mixnet is encrypted multiple times and sent through a sequence of nodes, each of which removes a layer of encryption, until the last mix node sends the message to its final destination. Differently from onion routing, however, mixnets route each individual message independently. Critically, what differentiates mixnets from VPNs, Tor, and alternative anonymous communication systems is that mixnets are designed to provide metadata protection from global network adversaries. Mix nodes achieve this by reordering the messages they route in addition to transforming them cryptographically. This makes messages indistinguishable both in terms of appearance as well as timing. Mixnets thus provide stronger metadata protection than Tor or any of its alternatives.

Traditional authentication systems allow the identity provider to monitor all connections to service providers made by users, which violates user privacy. Adding cryptographic constructions still requires the issuer of the privacy-preserving credentials to be the same centralized entity that verifies the credentials.

No system has yet successfully taken advantage of tokenized-based incentives to create an economically sustainable network that provides privacy against powerful network adversaries at scale. At the same time, blockchains that feature token incentives still depend on peer-to-peer broadcast networks that often provide little to no privacy, and in the best case protect only against weak adversaries who lack the ability to observe a large portion of the peer-to-peer network.

Tor and similar decentralized anonymous communication suffer from stagnant growth due to the lack of economic incentives for node operators. Tor is dependent on crowdfunding, non-profit, and government grants for software development and maintenance. These grants do not cover the costs of running and maintaining the relays in the Tor network itself, a cost borne entirely by volunteers. In contrast, centralized systems like VPNs have been economically successful but at the cost of authenticating their users in a centralized fashion for payment purposes of the servers running the VPN software. This centralization leads to risks of user data theft and attacks, as well as lack of dynamic scalability in the face of increased demand for anonymous communication.

Tor and similar decentralized anonymous communication systems that do not have authentication may easily suffer from denial-of-service attacks and sybil attacks, where malicious actors run nodes in order to capture user information or compromise the anonymity of the system. Therefore, an anonymous communication system needs to be integrated with an authentication system. However, this seems to be a paradox, as authentication will de-anonymize users.

Implementations of the disclosure address the above-mentioned deficiencies and other deficiencies by providing a method, system, device, and/or apparatus to publicly verify user information with a decentralized system for authorization and cryptographic authentication without requiring usernames, passwords, or hardware tokens. The method, system, device, or apparatus described throughout this detailed description may utilize a token, called the NYM token (also referred to herein as a mixnet access token, blockchain token, or token) for user authentication that is publicly verifiable and decentralized. The NYM token also serves as an incentive for the honest behavior of the independently run nodes in the protocol and so serves as an incentive. Put another way, the use of a token in the systems and methods described herein creates a system where the token itself is an incentive to network participants to participate in the network. The NYM token may be indexed to numerical values of any kind as determined by the interactions of the entire process. The NYM token allows authentication for finite periods of time (also referred to herein as epochs) where the transfer of an NYM token for authentication can fulfill the same functionality as other credentials in prior art, but unlike prior art can be verified and created in a decentralized manner while maintaining user privacy.

In one embodiment, a user may authenticate to any service that accepts NYM tokens, which may be used in the place of passwords, OAuth, and other authentication and authorization systems.

One advantage of using the NYM token for authentication may be to enable a user to be able to freely choose between which services they want while protecting their personal data or identity. Another advantage of the NYM token may be that the actions of users may be unlinkable by service providers between both authentication at different times to the same service provider and between authentication to different service providers. Another advantage of the NYM token may be to enable the user to reveal only what personal information they desire. For example, a user may create a long-term profile or persona, possibly a pseudonym based on a selected subset of their identity or a per-service long-term key and authorize the transfer of only the personal data that they explicitly choose to reveal to the service. Another advantage is that the actions of the users may be unlinkable between service providers and users, or even two instances of the same service provider. Another advantage is that parts of the infrastructure used for verifying user attributes and issuing tokens cannot link users to actions without their permission.

Another advantage of the NYM token may be to enable users that need stable pseudonymous identifiers to create a username and attach to wallets or contacts lists, long-term pseudonymous accounts may be created that are provably unlinkable to their real identity or other pseudonymous accounts while populating their pseudonymous profiles with data from their own devices. Another advantage of the NYM token may be to enable service providers to provide adequate resources for users while respecting user-freedom and user-privacy. Another advantage of the NYM token may be prevented denial-of-service attacks and abuse (such as sybil attacks), while respecting user-freedom and user-privacy.

Another advantage is that the NYM token allows mixnets to scale and mixnets provide strong anonymity, but have no way to dynamically scale or to track the reputation of the mix nodes that comprise the network or to prevent abusive use of the anonymous communication system. The NYM token serves as a measure of reputation for the mixnet, where nodes that successfully mix packets can receive NYM tokens. Then only nodes that provide a high quality of service can be selected for future work. New mix nodes will be attracted to part of the system and earn rewards. The use of the NYM token to access the network also then prevents denial-of-service attacks.

Put another way and further expanding on what has been stated above in the detailed description, the embodiments described herein of the systems and methods afforded by the utilization of a decentralized incentivized mixnet provides many beneficial applications, such as for example:
Cryptocurrency wallets: While there are some Tor-enabled cryptocurrency wallets, there is demand for privacy-enhanced wallets that enable both private transactions and privacy at the network level to secure the identities of users from third parties.
DeFi: Decentralized finance needs transactions to be indistinguishable, including sender anonymity on the network-level, in order to prevent front-running and enable darkpools, as per mature institutional markets.
Payment channels: Due to their network structure, off-chain payment channels are vulnerable to many attacks that a mixnet would ameliorate.
Secure Messaging: Current secure messaging applications use sophisticated end-to-end encryption, but expose metadata and do not resist traffic analysis of their servers.
File-sharing: In some cases, it is important to share sensitive large files in a way that preserves the anonymity of both the sender and the receiver - for example, in communication between journalists and whistle-blowers.
Identity management: Personal data, such as medical records, would benefit from the use of anonymous credentials and network-level privacy to prevent identity theft and algorithmic discrimination.
Multimedia Streaming: Audio and video conferencing is increasingly used for highly sensitive communication; because they can tolerate packets being lost and arriving out of order, these communication protocols are suitable for usage with a mixnet.

In some embodiments described herein, the decentralized incentivized mixnet may include a variety of participants. For example, the participants may comprise three types of nodes that make up the Nym infrastructure: validators, gateways, and mix nodes. Third-party service providers can make themselves accessible via Nym to offer enhanced privacy to end users. Providers can also act as an interface between the components of the network and external components that do not require modification or even awareness of the mixnet system. For example, Nym can be used to anonymously broadcast Bitcoin transactions by means of a service provider that relays transactions received via the Nym mixnet to the Bitcoin peer-to-peer network.

The user base may include the users of all the services available via credentials and the mixnet who choose to communicate privately, whether to anonymously broadcast a transaction, access information, or maintain a messaging conversation with a friend. The larger and more diverse the user base, the better the anonymity provided to all users and the more cost-effective the network becomes.

Mix nodes may provision communication privacy to end users by relaying data packets anonymously. Mix nodes are organized in a network, called mixnet, and packets traverse multiple nodes before being delivered to their final recipient. Mix nodes receive data packets that they both (1) transform cryptographically and (2) reorder, such that it is not possible to tell which input packet corresponds to which output, neither based on data content nor on timing. The Nym mixnet, includes further features for reliable transport, scalability, sybil protection, fair routing, quality-of-service measurements, incentives, and other modifications and extensions needed for real-world deployment. Thus a mix network is a network of mix nodes arranged in a layered topology, each mix node performing the task of an overlay router that transforms and reorders messages such that message inputs cannot be correlated with message outputs, and in a decentralized mixnet message inputs are routed according to contact information stored on a blockchain.

Gateways make the Nym mixnet accessible while protecting it from free riding. Participants may choose to always use the same gateway for all their traffic, split their traffic over multiple gateways, The Nym Network or pick a different gateway every day. Gateways also cache received messages for participants who are offline or unreachable, and are instrumental in the implementation of reliable transport features.

Validators collaboratively perform several core functions in the Nym network. They may serve as issuing authorities for the credentials. They maintain the Nym blockchain, which acts as a secure broadcast channel for distributing network-wide information, such as: the list of active nodes and their public keys, network configuration parameters, periodic random beacons, participant’s stake, deposits into the pool (the shared pool of funds used to support the Nym network, described herein), rewards distributed from the pool, and any other data that needs to be available to all participants to ensure the secure operation of the network. In addition, validators issue credentials to participants in a distributed manner. Certain kinds of credentials encode a proof of deposit in the pool made in exchange for an allowance of data to send through the Nym mixnet. These credentials are shown to gateways to prove the right to send traffic through the mixnet. Other credentials can encode arbitrary attributes required for proving “right to access” to a service, including proofs of having made a deposit in the to pay for the service.

The system may not be a standalone service; it may be an infrastructure that supports privacy for a broad range of third-party applications and services accessible through it. Service providers can send and receive messages through the mix network to privately communicate with their users, as well as optionally use credentials for granting paid access to their services without requiring privacy-invasive user identification.

Furthermore, the use of tokens in the network may incentivize network participants to both utilize the network and maintain the network. As such, as used herein the terms token, blockchain token, and NYM token may be considered interchangeable for purposes of the operation of the systems and methods described herein.

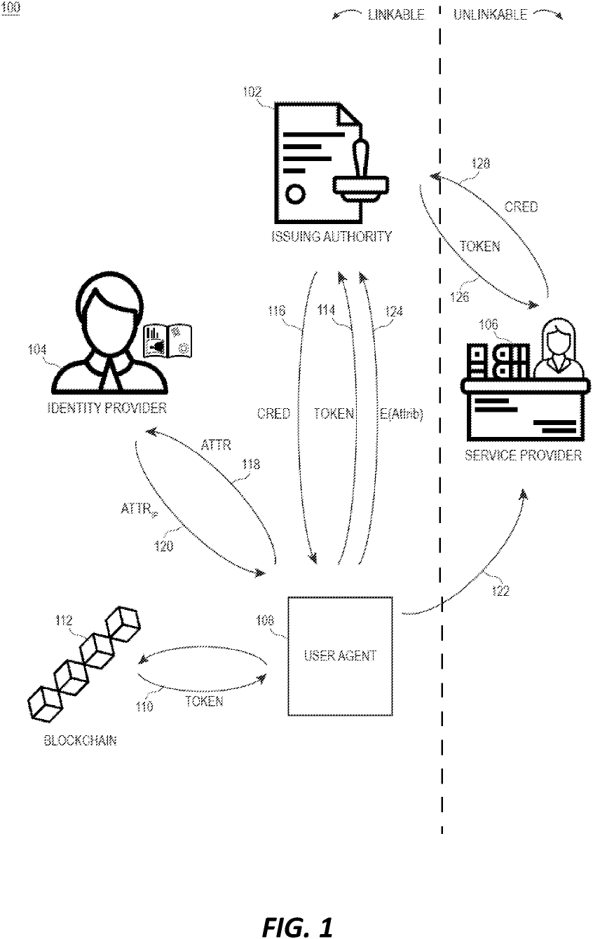

FIG. 1 illustrates an example decentralized incentivized mixnet 100 in accordance with some embodiments. The system 100 includes several components communicatively coupled in the arrangement illustrated in FIG. 1 including an issuing authority 102, an identity provider 104, a service provider 106, and a user 108. In other embodiments, there may be more or less components than pictured herein.

In one embodiment, when a user wants to engage with a NYM service provider 106, the user 108 may determine how many NYM tokens and what attributes are needed to access the service provider 106. In one example, the service provider 106 may advertise the number of NYM tokens and the attributes needed to use their service publicly.

When the system 100 has been initialized, one or more cryptographic keys may be generated for each component for purposes of carrying out the operations disclosed herein. These keys may be used for one or more epochs. In one embodiment, new cryptographic keys may be generated at the end of each epoch, and these keys may be changed over time. Each component has a wallet that is capable of sending and receiving NYM tokens and maintains a balance of NYM tokens.

In one embodiment, a user 108 may desire to use privacy-enhanced services to control what data is revealed about themselves. In another embodiment, the user 108 may desire to create and use different personas (for example, work vs. leisure personas) or be completely anonymous when using a decentralized authentication system. Each user has a long-term public and private key-pair encryption and may have another pair for signing..

The method may include the user 108 obtaining one or more, as well as fractional, NYM tokens at operation 110. A transfer of NYM tokens at 110 into a wallet of the user 108 may be recorded on the custom NYM blockchain 112. In another embodiment, the transfer of the NYM tokens may be recorded on another, pre-existing blockchain. The NYM token may be given to the user 108 or purchased legally via whatever means are authorized at the time. In one embodiment, a key used by the user for their wallet may not be a long-term key for the user 108.

In another embodiment, when the user 108 does not have the required NYM tokens, the service provider 106 may redirect the user 108 to whatever active services there are for obtaining NYM tokens. In another embodiment, the service provider 106 may give NYM tokens to the user 108. In another embodiment, the service provider 106 may transfer a cryptographic credential to the user.

In one embodiment, the NYM token may be transformed into a cryptographic credential used for privacy-enhanced authentication by embedding both service-specific and/or account-specific information with the NYM token at operation 114 and have the issuing authority 102 validate the transformation of the NYM token into a credential at operation 116. This may involve the user 108 collecting and aggregating partial shares in a cryptographic credential. Before transforming NYM tokens into a credential, the user 108 may determine a collection of attributes needed to access the service, collects the attributes from one or more identity providers 104 at operation 118 or cryptographically sign the attributes themselves, and combine the collection of attributes with a number of NYM tokens needed by the service provider 106 to form a credential.

In one embodiment, services that operate on the basis of user accounts, such as secure messaging or email providers, may use a long-term identity to allow access to contact lists and media associated with an account. In one embodiment, the credentials may be used to derive per-service pseudonyms and prove that only a valid user may access this long-term identity. This long-term identity may be a pseudonym or an identity with limited information disclosure (a “personae”). The long-term identities provide long-term credential from the same user and the credentials may be unlinkable to the credential issuance or to pseudonyms in other services.

In another embodiment, to prevent abusive or malicious users from opening many malicious unlinkable long-term accounts, the service provider 106 may make users’ identities traceable to a long-term user identifier identity independent of their credential and account. In one embodiment, this may be a key. In another embodiment, it may be a user identifier. For example, the user’s long-term identity may be encrypted under a public key of a number of abuse verifiers chosen by the service. When abuse is detected and all abuse verifiers agree there has been valid abuse, those abuse verifiers may decrypt the long-term identity of the user. NYM wallets may ensure users are aware of such ‘escrow’, including who the abuse verifiers are. In this example, users 108 may select whether or not to use service providers that may trace long-term identities for abuse prevention.

In one embodiment, to prevent timing attacks, the NYM token may be transformed into the credential at the beginning of a block or epoch of a blockchain whether or not the service is used. The credential may be used by a user to authenticate to a service provider.

In another embodiment, when the user does not have the attributes and/or NYM tokens needed for the service and so cannot trigger the transformation of NYM tokens into a credential, the user may be redirected to a special service provider called an identity provider 104. In one embodiment, the identity provider 104 may be selected by the service provider 106. In another embodiment, the user 108 may identify or select an identity provider from a list of identity providers.

The user 108 authenticates to the identity provider 104 using one or more methods employed by the identity provider, which may vary based on the type of identity provider.

In one embodiment, an identity provider 104 may have a public signing key pair, so the method may include the user may send attribute certificates with evidence to the identity provider 104 for verification one or more times at operation 118 and receive a signed attribute certificate at operation 120.

In one embodiment, the identity provider 104 may have an existing relationship with the user 108 (such as a government entity or an affinity group of activists) and may verify their identity for the pseudonymous account. An attribute certificate may include both attributes that are public to the verifying entity and/or private attributes given by commitments or encryption. For example, these private attributes can be encrypted under the key of the user 108. The public and/or private attributes may be signed under the key of the identity provider 104. In one example, once an identity provider 104 is assured of the identity of a user 108, the identity provider may sign attributes it can verify. In another example, once an identity provider is assured of the identity of a user 108, the identity provider 104 may sign blindly sign encrypted attributes.

In one embodiment, for services with long-term accounts, a possibly pseudonymous per-service user identity and public key material may be issued by the identity provider 104. In one example, for a service provider 106 that uses long-term accounts with a user identifier, the user 108 may encrypt their identifier and its public key, and the identity provider 104 may send the signed attributes to the user 108. In one example, the user 108 may use another per-service key-pair’ in their attributes rather than its own long-term public key pk. In one example, when the attributes are encrypted, the identity provider 104 may not gain knowledge of the identifier or public key material used by the service.

In one embodiment, when an identity provider 104 is not required, the user 108 may create whatever attributes are needed locally or retrieve the attributes from whatever service the user trusts and the user can also self-sign these attributes so that it can send user attributes rather than identity provider attributes to the service provider 106 at operation 122.

In another embodiment, the methods above may be combined so that attributes can have multiple origins but be combined together to form a single attribute to be used with a NYM token. In one example, for fully anonymous short-term access to a service, only attributes necessary to run the service or even no attributes may be embedded in the NYM token.

The system 100 may include the user starting the issuance of an NYM credential by associating zero or more encrypted attribute certificates with the required number of NYM tokens at operation 124. Optionally, so the attributes are not linkable by the issuing authorities.

The information may be encrypted using re-randomizable encryption and signed with an anonymous aggregate signature scheme to let each authentication with the credential be unlinkable to the user and any other transaction. One embodiment uses El-Gamal as the re-randomizable encryption scheme and the Coconut as the anonymous aggregate signature scheme. Another embodiment uses polynomial commitments.

A distributed credential issuing procedure of the attribute-based credential scheme may be triggered by sending the required encrypted attributes with the required NYM token at operations 114, 124 to one or more issuing authorities 102. This produces the distributed credential at operation 116 by having multiple issuing authorities sign the encrypted credential (also referred to as a blindly signing the credential),

In one embodiment, the NYM token value is given a serial number by the issuing authority 102. In another embodiment, the serial number is given by the user 108. In one embodiment, the serial number is cryptographically transformed by using it as the exponential to a group element, the input to a hash function or commitment, or another suitable cryptographic construction with an information hiding property. In one embodiment, the transformed serial number of the transaction is written to the blockchain by the issuing authorities. In another embodiment, the serial number of the transaction is stored in a smart contract.

In one embodiment, the value transfer is marked as an unconfirmed transaction on the blockchain 112 until the use of that serial number by a service provider 106 is confirmed by the issuing authority 102. In another example, an NYM token may be represented as an token that can be distributed via a smart contract where the transfers to the smart contract can be recorded on the decentralized system via a holding contract.

In one embodiment, the use of the credential with an amount in NYM token or another numerical value in a transaction with a service provider 106 or another user that requires y NYM token or another numerical value may result in the creation of another credential with x-y NYM token via a split and merge operation.

In one embodiment, the key of the user 108 the public keys are transformed to preserve forward secrecy in case they are compromised.

The credential may be bound to the user 108 by including an encrypted user private key with the credential. The encrypted user private key may include a value of the NYM token v′, the serial number s to prevent double-spending, an expiry epoch, and encrypted attributes, where the credential consists of a an output of the serial number given by a cryptographic operation with an information hiding property.

In one example, the NYM token may be fractional to allow the transformation of NYM tokens to a credential at a variable rate that matches a demand for privacy-enhanced authentication and the supply of privacy-enhanced services. In another example, the NYM token may only be transformed one-to-one into a credential.

In one example, the system recording of serial numbers and checking of serial numbers may be implemented as a smart contract on the Ethereum blockchain. In another example, the recording of serial numbers may be done on customized blockchain by the issuing authority 102.

In one example, the method may also include the user transferring NYM tokens from the wallet of the user 108 to the service provider 106 and the issuing authorities 102 to confirm the transaction at operation 114. In another example, the tokens may be transferred to a holding account controlled by a smart contract before being transferred to the service provider 106 that can prove they have received the equivalent credential. In one embodiment, the equivalence between the credentials and the tokens is given by serial numbers.

Once a credential is signed by a subset of the issuing authorities 102, the signatures of the issuing authorities 102 are merged in order to create an aggregate signature. The user 108 recombines these credentials to produce a valid aggregate signature on the credential. In one embodiment, binding the credential to the user 108 may be distributed and fault tolerant using threshold cryptography, so only two-thirds of the issuing authorities need to be available and up to one-third may be malicious.

If the credential is valid via checking the signature of the issuing authority 102, then the issuing authorities 102 may confirm the transaction of the tokens from the user to the service provider 106. For example, to confirm the transaction of the tokens, the NYM tokens with corresponding value v may be transferred to the account of the service provider 106 on the NYM blockchain 112 and the NYM tokens transaction is marked as confirmed on the blockchain 112 by the issuing authority 102.

In one embodiment, the transactions may be confirmed using a centralized authority or another channel for payment.

In another embodiment, a user 108 can purposefully link the credential to a long-term account by embedding a long-term per-service identifier (also referred to as a pseudonym). In another embodiment, privacy-enhanced services may not be required to create their own payment infrastructure that could be used to de-anonymize users but would be able to receive NYM tokens in proportion to the amount of service-use while maintaining user privacy.

The method allows the user 108 to show the credential to other entities to reveal both public and private attributes. This may include a user 108 showing credential to a service provider 106 at operation 122. For example, upon issuance, a user 108 may re-randomize the credential to ensure that any subsequent showing of the credential for authentication is unlinkable to any colluding number of issuing authorities, any long-term identifier of the user 108 at any identity provider, and/or any information that can be deduced from the transactions on the blockchain 112 itself. In one example, blinding of the credential may occur currently via re-randomization of the ciphertext of the credential. In one embodiment, when the signed credential is unlinkable, the user 108 may perform a selective disclosure credential show procedure to prove possession of a valid NYM credential to a service provider 106. In another embodiment, when the signed credential is unlinkable, the user 108 may reveal service provider-specific attributes. In one example, showing a credential may produce a publicly verifiable signature that shows a validity of the credential. In one example, showing the credential may produce a cryptographically hidden serial number that is used to prevent double spending of the same credential. In another example, user attributes or pseudonyms may be revealed while their validity is guaranteed.

Once a credential has been shown, the service provider 106 should check the validity of the credential. For example, the service provider 106 may verify via checking the serial number if the credential has been spent before, if the credential is within its valid epoch, and if the aggregate signatures of the issuing authorities is valid.

In one embodiment, interactions for verification may use proof-systems like zero-knowledge proofs in a mode that does not require further interactions with the issuing authority 102.

In one embodiment, in order to increase the anonymity set, the credentials that are valid but not used in a given epoch may be refreshed to allow the anonymity set to increase to the credentials that have not already been shown in any epoch. In another embodiment, users may selectively link of their identities by their own service providers in order to enable long-term accounts. In another embodiment, different types of service providers may require different types of attributes to provide access, as well as different levels of linkability to long-term identifiers. NYM tokens may support all policies and ensures users are in control of revealing the type of information that service providers require from them:

In one embodiment, on-demand media downloads and VPN usage may only require showing a credential containing NYM token without any further attributes, allowing anonymous but authenticated access. In another embodiment, services for online collective decision-making platforms may only require that the same user did not perform an operation, such as voting, more than once. In one example, the gateway and service provider may derive a per-action serial number attached to a user in their attribute certificate from their private key to ensure that a user performing the same action twice is detected.

The method may include the user proceeding to use the service provider’s services for the epoch after the user has successfully shown a valid credential to the service provider 106.

In one example, the service provider 106 may then prove they have received a given number of credentials in a given epoch to receive the NYM tokens embedded in these credentials.

The method may include the issuing authority 102 confirming a transfer of the tokens to the service provider 106 at operation after the service provider 106 has demonstrated they are in possession of a valid credential at operation 128. In one example, the service provider 106 may receive a value transferred in the NYM token to the service provider, receiving an amount of token for each user 108 per epoch.

In one example, the service provider 106 may exchange the resulting sum of NYM tokens to fund operations of the service provider 106 to provide services to the user 108. In one embodiment, the service provider 106 may sell the NYM tokens on an exchange in order to provide funding for the operations of the service provider 106.

In one embodiment, NYM tokens may be issued every epoch and indexed to expected capacity of the service providers 102 via a proof-of-stake mechanism. In one embodiment the number of NYM tokens may be indexed to a capacity. In another embodiment, the number of NYM tokens may be indexed to the number of credentials a service provider can prove they received over one or more of the previous epochs. By indexing the NYM tokens to a resource such as the capacity of one or more of the decentralized system of service providers 106, the service providers 106 may issue reasonable guarantees to provision services and prevent sybil attacks or denial-of-service attacks. The amount of NYM tokens is recorded on the blockchain 112. In one embodiment, the NYM tokens may be indexed based on the number of credentials to the supply of NYM tokens.

As discussed above, the incentivized mixnet 100 that uses an NYM token may decentralize authentication services while adding privacy. An NYM token user may authenticate the user 108 without revealing any information that the user may choose not to reveal to a third-party. The decentralized authentication system 100 that uses an NYM token may disintermediate privacy-enhanced service providers that provide services that include authentication, identity providers that authenticate any identity information, and issuing authorities that provide privacy-enhanced credentials that are used to access service providers.

An NYM token may be used as a voucher for a future use of a privacy-enhanced service in a given epoch, such as sending a certain number of messages within a messaging service or using a certain capacity of data through a VPN service.

The end-user experience of the incentivized mixnet 100 with NYM tokens may appear to be the same or similar to conventional authentication systems without NYM tokens from the perspective of the user 108. When the user 108 wishes to authenticate to a service provider 106 with NYM tokens, the user may be asked to authorize an identity provider 102 by using a credential. For example, a user 108 may create a credential valid for the length of the epoch at the beginning of the epoch. In another example, if the user 108 already has a credential valid for that service, then the user automatically accesses the service privately.

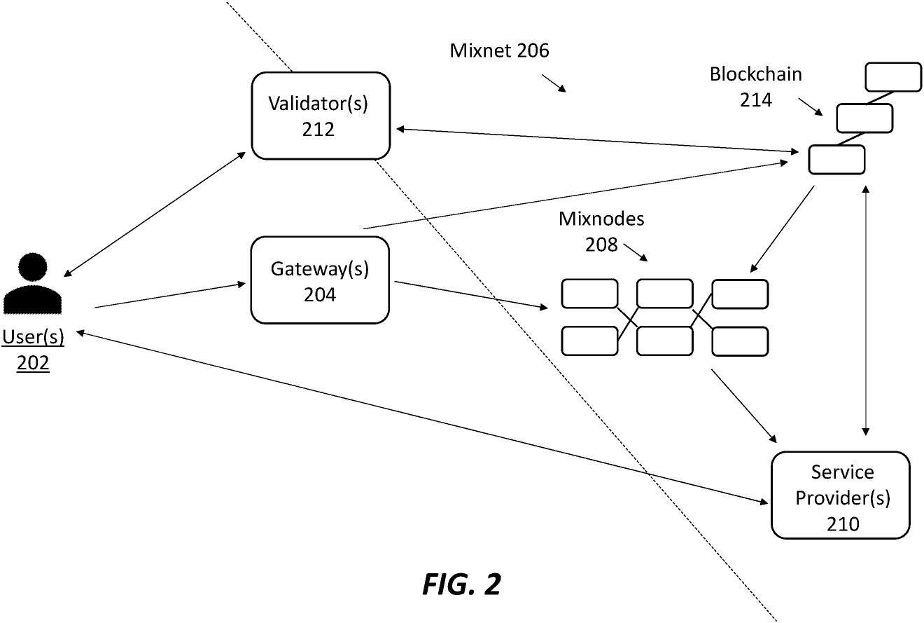

FIG. 2 illustrates an example architecture for a decentralized incentivized mixnet with a blockchain token according to an embodiment. The architecture may include users 202, gateways 204, a mixnet 206, mixnodes 208, service providers 210, validator nodes 212, and a blockchain 214. In other embodiments, there may be more or less components than pictured herein.

In some embodiments of the system shown in FIG. 2, users 202 may deposit funds in the pool to obtain credentials. The users may use the credential to gain access to a gateway 204. The user may use the credential in order to prove their “right to use” the mixnet. The user may establish temporary connection with the gateway while their credentials are validated. Until the data allowance of the credential is consumed or expired, the user can send traffic to the Nym mixnet via the gateway. The mixnet routes user messages anonymously, at each step making inputs unlinkable to outputs. The system may mark a received credential as “used” for all the network participants to see it has been used to prevent double spending. At periodic intervals, validators algorithmically distribute rewards from the shared pool of funds. This includes rewards destined to nodes (mix nodes, gateways, and validators) for their work maintaining the core Nym network, as well as rewards to service providers that redeem credentials received from users in exchange for services.

In another embodiment of the system shown in FIG. 2, the system may take the following steps: a user sends token and received credential from Validator, User sends credential to Gateway, Gateway relies on Validator Nodes for decentralized credential validation, Gateway provides User access to mixnet, mixnet allows anonymized access to Service Providers, Service Providers keep track of user credentials via blockchain, and validators and Mix Nodes receive token rewards.

In detail in FIG. 2., the user first makes a token deposit in a shared pool of funds. In one embodiment, this shared pool of funds is managed by the validators using a smart contract. In one embodiment, this token deposit is recorded on the blockchain. In another embodiment, this deposit may be private and recorded in a database.

The user converts part of their deposit of NYM token into a credential. The user generates the unsigned credentials together with any needed proofs and submits them to one or more validators. In one embodiment, the proof of the deposit in the shared pool of funds is needed. In another embodiment, another proof could be a signed attestation of from an external identity provider.

If the credentials and any necessary proofs are correct, the validator can issue a signature on the credential. In one embodiment, the validators may check the pool of funds on the blockchain for proof of deposit by checking the blockchain. In another embodiment, the validator may check with an external identity provider. In one example, the credential sent by the user is encrypted so that attributes are not linkable by the issuing authorities.

In one embodiment, the credential is given a serial number and its creation is marked as a commitment on the blockchain. Then the use of that serial number by an service provider or gateway can be confirmed by the validator. In one embodiment, anyone can confirm.

The user may ask one or more validators, and collect a number of signatures on each credential. Using an anonymous aggregate signature scheme, the user collects a threshold number of signatures to combines all these signatures into a valid credential. Therefore, this signature can be issued in a decentralized manner, so that even if one or more validators are not responsive, as long as enough validators are responsive, the credential is valid.

Once a credential is issued, a user may unblind and randomize their credential. In one example, the user may re-randomize the credential to ensure that any subsequent showing of the credential for authentication is unlinkable to any colluding number of issuing authorities, any long-term identifier of the user at any identity provider, and/or any information that can be deduced from the transactions on the blockchain itself.

The method may include refreshing the credential where the credential is given a new public validity epoch by sending the same credentials to the validator and the necessary proofs that the credential is still valid. For example, this may include proof that the credential has not been spent by inspecting the commitment on the blockchain.

The user shows the credential to get access to the gateway to access the mixnet. In one embodiment, the user selects a gateway according to their own personal criteria and uses a credential to prove their “right to use” the mixnet based on their deposit. In one embodiment, on-demand media downloads and VPN usage may only require showing a credential containing proof of spending of NYM token without any further attributes, allowing anonymous but authenticated access to the mixnet.

The gateway checks that the credential presented by the user is valid. In one embodiment, the gateway checks that has not already been marked as spent in the blockchain. The gateway submits to the validators a commitment to the serial number encoded in the credential that they publish in the blockchain. This commitment marks the credential as used and prevents its double-spending in the future. It also allows gateways to prove the share of traffic they have routed so they can receive proportional rewards in NYM token.

If the credential is not valid, in one embodiment then the user is not given access to the mixnet. In another embodiment, the user is not given any services available.

After the credential has been shown to be valid, the user and the gateway establish a communication channel associated to the data allowance on the mixnet represented by the credential. In one embodiment, there is a validity period represented by the credential. In one embodiment, the channel is given a shared secret between the gateway and the user.

Then the user may route traffic via the mixnet as an anonymous communication channel. The mixnet routes user messages anonymously, at each step making inputs unlinkable to outputs. In one embodiment, the channel is open until the data allowance of the credential is consumed, the user can send traffic to the mixnet via the gateway. In another embodiment, the channel only lasts for a temporal epoch, such as a day or month, and after that epoch has expired a new payment must be made to the pool of funds.

In one embodiment, the gateway may package messages from the user into a unlinkable packet format needed to be anonymous on the mixnet. In another embodiment, the user may package messages into such a packet format on their device.

In the creation of the packet, it may use source routing, where the sender of a message chooses the route that the message will traverse before reaching its final destination. This choice is made according to the mixnet’s public parameters and routing policy, which assigns mix nodes to mixnet layers and distributes traffic among the nodes of a layer weighted according to node capacity.

In one embodiment, the gateway may receive messages on behalf of the user. These messages may be retrieved by the user who can use a credential to authenticate to the gateway. In one embodiment, private information retrieval may be used to check one or more gateways in a privacy-enhanced manner for new messages or for sending new messages.

In one embodiment, the user may send cover traffic from their device to the gateway. Cover traffic is dummy traffic that increases the anonymity and is indistinguishable from normal packets by using an unlinkable packet format. Cover traffic disguises real traffic patterns by adding dummy messages that carry no payload data and are simply discarded at their final destination. While routing a message, mix nodes cannot distinguish whether it is a dummy message or a normal message carrying user data.

When a mix node receives a message, it strips a layer of encryption using its own private key material, retrieves information for routing the message to the next hop, and cryptographically transforms the message, rendering it unrecognizable. The mix node also retains the message a randomized amount time before forwarding it to the next node in the message’s route. In one embodiment, the randomized amount of time is chosen by a Poisson process so that the average time needed to send a packet across the mixnet can be predicted, even if the individual time a message takes cannot. In one embodiment, the amount of time a message dwells in a node is chosen by the original sender and encoded in the packet format given to each mix node. In another embodiment, the amount of time a message dwells at a node is given by a verifiable source of randomness. In another embodiment, the amount of time a message dwells at a node may even be chosen by the node itself.

In one embodiment, the message packet may include special single-use reply blocks or groups of single-use reply blocks to allow responses to message. A single-use reply block are pre-computed packet headers encoding a mixnet route that ends in the participant that created the single-use reply block.

Loop message traffic is cover traffic sent in a loop throughout the network, where the sender and receiver may by the same. In one embodiment, loop messages are generated by mix nodes to ensure that there is sufficient traffic in the network over time, and thus guarantee large anonymity sets and high levels of privacy. In one embodiment, loop messages are generated at random intervals that follow a Poisson process.

In one embodiment, sending cover traffic in routes that loop back to the sender enables both users and mix nodes to maintain local updated knowledge on the health of the network, including the ability to detect when nodes go down, are congested, or under attack.

At epochs, validators algorithmically distribute rewards from the shared pool maintained by the validators. This includes rewards destined to nodes (mix nodes as well as possibly gateways and validators) for their work maintaining the core network, as well as rewards to service providers that redeem credentials received from users in exchange for services. In one embodiment, these rewards may be distributed by a reward-sharing scheme. In one embodiment, the use of loop traffic can determine in a verifiable manner if the nodes are online and functioning according to the protocol.

In one embodiment, the service provider and mix nodes may receive a value transferred via the NYM token to the service provider at the end of the epoch. In one example, the service provider or mix nodes may exchange the resulting sum of NYM tokens to fund the service provider operations to provide services to the user.

The network of mix nodes can reward individual mix nodes over time, the rewarding being based on a prediction of the reliable provisioning of network capacity by the individual node paid out from rewards and fees paid by users of the incentivized mixnet.

At the end of each epoch, the mix network may randomize the placement of nodes in each layer.

At the end of each epoch, the mix network may select nodes based on their amount of NYM token for inclusion in the network, and may also remove nodes with less token.

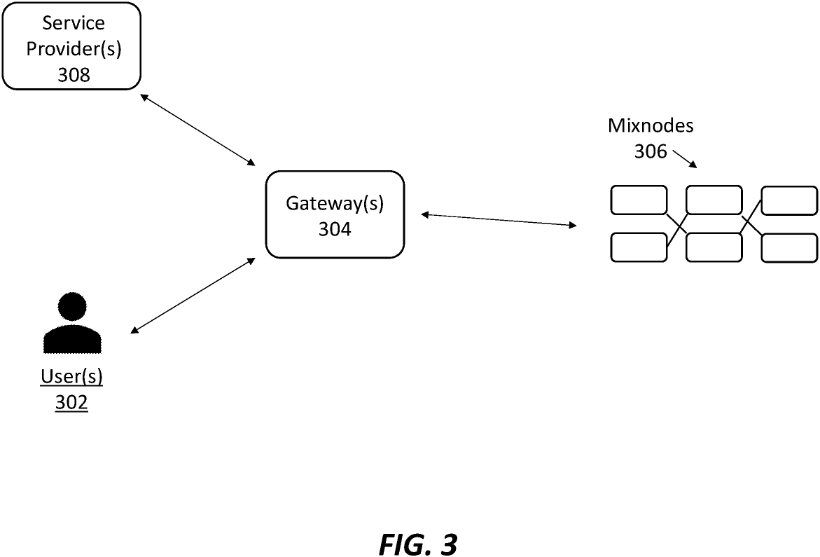

Each mix node in the network of mix nodes pledges an amount of a NYM token or is otherwise assigned an amount of NYM token in proportion to how much mixing of traffic they can do. FIG. 3 illustrates an example system for users and services to communicate privately according to an embodiment. The system may include users 302, gateways 304, a mixnet 306, mixnodes 308, and service providers 310. In other embodiments, there may be more or less components than pictured herein. In other embodiments, there may be more or less components than pictured herein. In some embodiments, the mix nodes may use trusted hardware to ensure they are performing their role in the network honestly. Likewise, the validators may also use trusted hardware to ensure they are performing their role in the protocol fairly.

In one embodiment of the system in FIG. 3, a user 302 may send data anonymously via the gateways 304, mixnet 306, mixnodes 308, to a service provider 310. Similarly, a service provider 310 may send data anonymously via the gateways 304, mixnet 306, mixnodes 308, to a user 302.

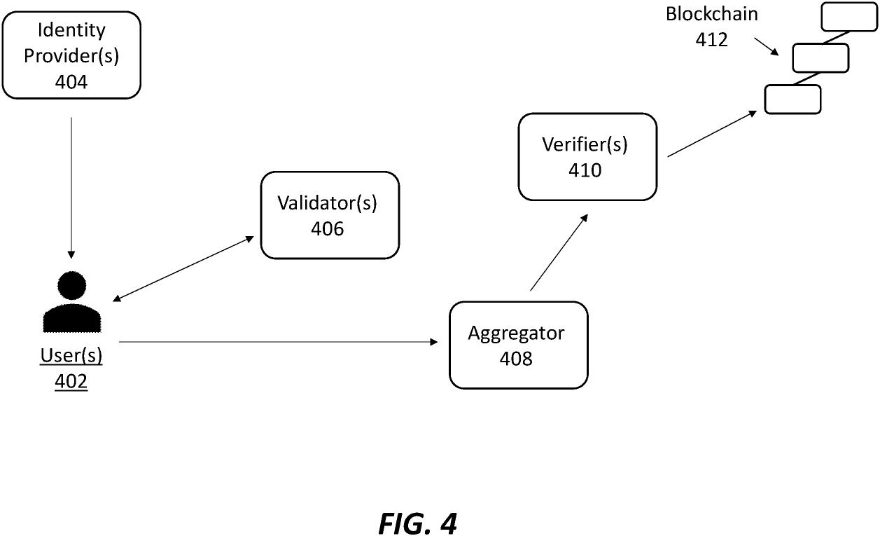

FIG. 4 illustrates an example system for obtaining and showing credentials according to an embodiment. The system may include users 102, gateways 104, a mixnet 106, mixnodes 108, and service providers 110. In other embodiments, there may be more or less components than pictured herein.

In one embodiment of the system shown in FIG. 4, the system may perform the following steps: a user collects attributes into credentials, the user sends credentials to a validator, validator returns signed shares, user aggregates signed shares into a full randomized credential, user shares credential to verifier, and a verifier checks Nym blockchain for double spending.

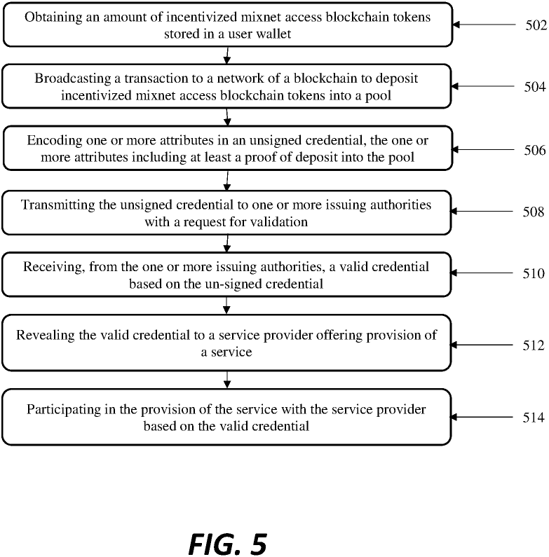

FIG. 5 illustrates an example flowchart for authentication on a decentralized incentivized mixnet. The functionality depicted in the flowchart may be executed via the computing processes of some of the components listed herein.

In one embodiment, FIG. 5 comprises: obtaining an amount of incentivized mixnet access blockchain tokens stored in a user wallet (502); broadcasting a transaction to a network of a blockchain to deposit incentivized mixnet access blockchain tokens into a pool (504); encoding one or more attributes in an unsigned credential, the one or more attributes including at least a proof of deposit into the pool (506); transmitting the unsigned credential to one or more issuing authorities with a request for validation (508); receiving, from the one or more issuing authorities, a valid credential based on the un-signed credential (510); revealing the valid credential to a service provider offering provision of a service (512); and participating in the provision of the service with the service provider based on the valid credential (514). In some embodiments, there may be one or more steps incorporated into the general flow of the method embodied in the flowchart.

In some embodiments, the systems described herein may perform similar functionality without the use of an incentive system that rewards system participants with tokens. Similarly, in some embodiments, the decentralized incentivized mixnet described herein may perform similar functionality with the use of a credential system, i.e., the system may allow any network traffic through the mixnet.

In one embodiment, the mix nodes of the mixnet may use secure hardware that may be run in a centralized manner, i.e., using a database or permissioned blockchain, to try to attempt to guarantee their honest behavior in the protocol. Similarly, in one embodiment, gateways to the mixnet may use secure hardware that may be run in a centralized manner, i.e., using a database or permissioned blockchain, to try to attempt to guarantee their honest behavior in the protocol.

The aforementioned systems and processes may be executed via known computing systems comprising computing processors and computing memories (that store executable code to execute the functionality described herein), as well as whatever necessary input/output components and other computing components.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

We claim:

1. A method for authentication on a decentralized incentivized mixnet, the method comprising:
obtaining an amount of incentivized mixnet access blockchain tokens stored in a user wallet;
broadcasting a transaction to a network of a blockchain to deposit incentivized mixnet access blockchain tokens into a pool;
encoding one or more attributes in an unsigned credential, the one or more attributes including at least a proof of deposit into the pool;
transmitting the unsigned credential to one or more issuing authorities with a request for validation;
receiving, from the one or more issuing authorities, a valid credential based on the unsigned credential;
revealing the valid credential to a service provider offering provision of a service; and
participating in the provision of the service with the service provider based on the valid credential.

2. The method of claim 1, wherein the valid credential is a credential with identity information.

3. The method of claim 1, wherein the valid credential is a credential to access the mixnet.

4. An incentivized mixnet comprising:
a network of mix nodes arranged in a layered topology, each mix node performing the task of an overlay router that transforms and reorders messages such that message inputs cannot be correlated with message outputs, wherein message inputs are routed according to contact information stored on a blockchain;
wherein each mix node in the network of mix nodes pledges an amount of a blockchain token; and
the network of mix nodes rewarding individual mix nodes over time, the rewarding being based on a prediction of the reliable provisioning of network capacity by the individual node paid out from rewards and fees paid by users of the incentivized mixnet.

5. The incentivized mixnet of claim 4, wherein the assignment of mix nodes to layers is randomized.

6. The incentivized mixnet of claim 4, the layered topology is reconfigured upon the passage of an epoch.
